(19) United States
(12) Patent Application Publication
(10) Pub. No.: US 2003/0081236 A1
(43) Pub. Date: May 1, 2003

(54) Adaptive preventive maintenance for hardcopy devices

(76) Inventors: Julio Sanabria Banos, Barcelona (ES); Carles Magrinya, Barcelona (ES); Jordi Aragones Valls, Barcelona (ES)

Correspondence Address: HEWLETT-PACKARD COMPANY, Intellectual Property Administration, P.O. Box 272400, Fort Collins, CO, 80527-2400, US

(21) Appl. No.: 09/984,836

(22) Filed: Oct. 31, 2001

(51) Int. Cl. B41F 1/00; G06F 15/00

(52) U.S. Cl. 358/1.14; 358/1.9

(57) ABSTRACT

A hardcopy device calculates and stores working speeds for subsystems in the hardcopy device. Estimated working speeds are calculated from the stored working speeds. Triggering values for generating alert messages based on the estimated working speeds are calculated, and a determination as to whether preventive maintenance is due is performed. An alert message indicating a preventive maintenance is due is generated in response to a total number of working cycles performed by a subsystem being greater than or equal to the triggering value.

### FIELD OF THE INVENTION

The invention is generally related to maintenance for hardcopy devices, including printers. More particularly, the invention is related to providing adaptive, preventive, maintenance alerts for hardcopy devices.

### BACKGROUND OF THE INVENTION

Preventive maintenance operates to retain a system in an available or operational state by preventing failures from occurring. The effectiveness and economic benefits of preventive maintenance can be maximized by taking account the time-to-failure distributions of the maintained parts and of the failure rate trend of a system.

Typically, a preventive maintenance procedure in a hardcopy device (e.g., printer, facsimile, photocopier, multifunction devices that incorporate multiple features of hardcopy devices) is triggered by means of an alert message flashing in the control panel of the printer. The message may suggest that the customer contact support service in order to perform scheduled maintenance on the printer.

Preventive maintenance is generally related to life/wear issues of printer subsystems (e.g., equipment subject to wear, corrosion, fatigue, etc.). This strategy is usually implemented to prevent users from performing non-scheduled printer repairs and to prevent unnecessary down time. With this purpose, cycle counters are typically built into the firmware of these products in order to control the aging of the printer subsystems.

During the product development phase, a printer's subsystem is often characterized in terms of the number of cycles the subsystem is capable of performing (i.e., the life of the subsystem). The maximum number of cycles that may be completed by the subsystem with a low damage risk is determined through reliability analysis. Currently, limits are set such that an alert message may be generated a predetermined number of cycles prior to reaching the low damage risk cycle threshold. This allows a user some margin to contact support service and schedule a maintenance operation.

The longer a user waits to complete a scheduled maintenance, the higher the risk of a subsystem failing. Therefore, it is critical to accurately determine how much time is available before reaching the cycle limit for a subsystem. However, to accurately determine the time available before reaching the cycle limit, the rate of subsystem usage is needed. With the conventional preventative maintenance trigger strategy, the heavier the working cycle, the smaller the amount of time the customer has to perform or request a preventive repair. Accordingly, the subsystem may have a high risk of failure when being heavily used. Also, the conventional preventative maintenance trigger strategy may prematurely request preventive maintenance, which increases the cost of parts for the system along with an attendant increase in time required to perform the maintenance.

### SUMMARY OF THE INVENTION

An aspect of the invention includes a method for adaptively triggering an alert message for a subsystem in a device. The method comprises steps of determining a rate of use of the subsystem; adjusting a predetermined threshold based on the determined rate of use; and generating the alert message for the subsystem when the adjusted threshold is reached.

The method of the invention includes steps that may be performed by computer-executable instructions executing on a computer-readable medium.

Another aspect of the invention includes an apparatus having a plurality of subsystems. The apparatus comprises a controller connected to a memory, at least one subsystem and an output device. The controller is operable to determine a rate of use of the at least one subsystem, to adjust a predetermined threshold based on the determined rate of use, and to generate with the output device an alert message for the subsystem if the adjusted threshold is reached. The apparatus may include a printer or other hardcopy devices. As discussed above, conventional hardcopy devices typically trigger an alert message for a subsystem after the subsystem performs a predetermined number of cycles, which is a predetermined number of cycles prior to reaching the low damage risk cycle threshold. For heavy users the number of cycles performed by the subsystem will be more than an average user or a moderate user of a hardcopy device. Therefore, for heavy users, the low damage cycle threshold may be relatively quickly, giving heavy users less amount of time to perform preventive maintenance. For moderate users, the number of cycles performed by the subsystem will be less than an average user or a heavy user of a hardcopy device. Therefore, for moderate users, the low damage cycle threshold may be reached later.

Certain aspects of the invention provide substantially the same amount of time for all types of users (e.g., heavy, average, or moderate) to perform preventive maintenance for a printing device subsystem through the use of an adaptively triggered alert message. By using the adaptively triggered alert message, the risk of failure of a hardcopy device may be reduced, the lifetime of a hardcopy device may be increased and costs for parts and labor may be minimized by providing a maintenance schedule that is adaptive to a user's actual use of a hardcopy device. Those skilled in the art will appreciate these and other aspects of various embodiments of the invention upon reading the following detailed description of a preferred embodiment with reference to the below-listed drawings.

### BRIEF DESCRIPTION OF THE DRAWINGS

The present invention is illustrated by way of example and not limitation in the accompanying figures in which like numeral references refer to like elements, and wherein:

FIG. 1 illustrates an exemplary system employing principles of the invention;

FIG. 2 illustrates an exemplary method for adaptively triggering preventive maintenance; and

FIGS. 3A-B illustrate graphic distributions of working speeds.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

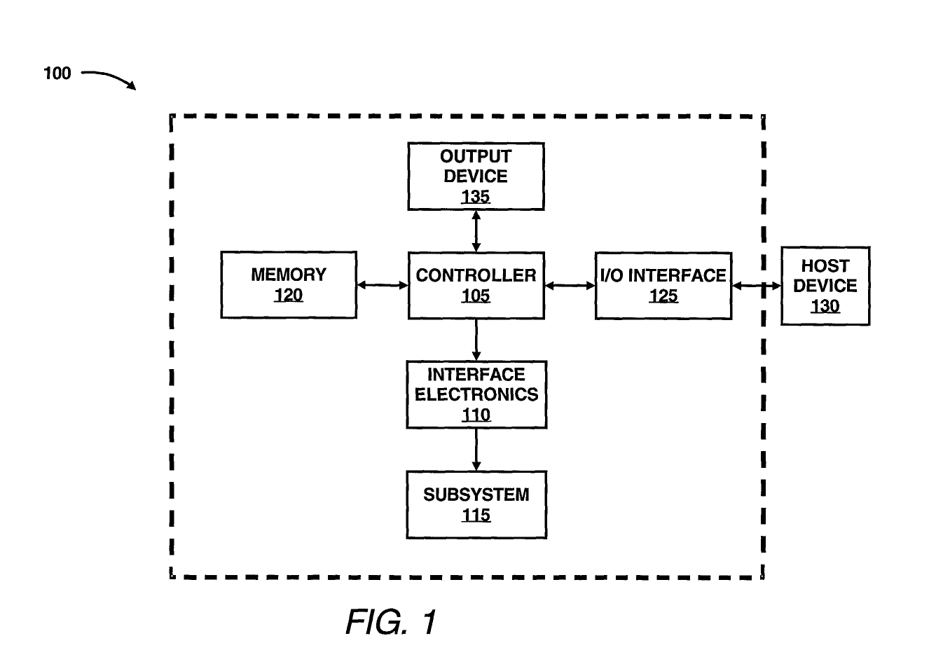

FIG. 1 illustrates an exemplary system 100 employing principles of the invention. The system 100 may include a hardcopy device providing adaptive triggering of preventive maintenance. The system 100 is generally described with respect to a printer. However, it will be apparent to one of ordinary skill in the art that the invention is applicable to a variety of systems, including but not limited to hardcopy devices other than printers (e.g., copiers, facsimile machines, etc.).

The system 100 includes a controller 105 connected to a subsystem 115 through interface electronics 110. The controller 105 is also connected to a memory 120, a host device 120 and an output device 135.

The controller 105 may be configured to provide control logic for the system 100 (e.g., the functionality for a printer). In this respect, the controller 105 may possess a microprocessor, a micro-controller, an application specific integrated circuit, and the like. The controller 105 may be interfaced with the memory 120 that is configured to provide storage of a computer software that provides the functionality for the system 100. The memory 120 may also be configured to store maintenance information for the subsystem 100. The memory 120 may be implemented as a combination of volatile and non-volatile memory, such as dynamic random access memory (“RAM”), EEPROM, flash memory, and the like.

The system 100 may be connected to the host device 130 (e.g., personal computer, server, personal digital assistant, and the like) through an I/O interface 125. The I/O interface 125 is configured to provide a communication channel between the host device 130 and the controller 105. The I/O interface 125 may conform to protocols such as RS-232, parallel, small computer system interface, universal serial bus, etc. The system 100 may include a standalone device, however, that is not connected to a host device.

The controller 105 is connected to the subsystem 115 through the interface electronics 110. The subsystem 115 may include mechanical, electrical or electromechanical parts in the system 100 that may be monitored for wear and/or performance. For example, for a printer system, a subsystem may include printheads, drop detectors, a service station, power supply, and the like. The controller 105 may monitor these subsystems and store maintenance information related to the subsystems in the memory 120. The interface electronics 110 may include conventional circuits that provide an interface between the controller 105 and the subsystem 115. It will be apparent to one of ordinary skill in the art that multiple subsystems may be monitored by the controller 105. Also, a subsystem may not require interface electronics, especially when electrical components rather than mechanical components are being monitored.

The controller 115 may also be connected to the output device 135 (e.g., a display, a speaker, a control panel having audio/visual output, and the like) for providing messages to a user. For example, based on the maintenance information stored in the memory 120, the controller 105 may determine that the subsystem 115 requires maintenance or may require maintenance shortly. The controller 105 can generate an alert message to a user through the output device 135 requesting that maintenance be performed or indicating other maintenance information. Also, alert messages and maintenance information may be transmitted to the host device 130, such that corrective action may be taken.

The maintenance information may include predetermined information and information monitored and calculated by the controller 105, which can include maintenance information for each subsystem and/or a plurality of subsystems monitored substantially simultaneously. The maintenance information may include working time (wt), working cycles (wc), working speed (ws), triggering values (tv), a maximum number of cycles performed without failure (cl), time limit to reach ‘cl’ (tl), a running total of the number of cycles performed by a subsystem, and the like.

Predetermined maintenance information includes the maximum cycles performed without failure (cl) of a subsystem. A cycle, for example, can include a repeated function performed by a subsystem (e.g., a carriage return, paper advance, dispensing a drop of ink from a nozzle for an ink jet printer, and the like). The ‘cl’ may be determined during development phase of the subsystem 115 in the system 100, and may include the maximum number of times a function can be performed without failure of the subsystem 115. The ‘cl’ may be stored in the memory 120.

The time limit (tl) is a period of time to complete ‘cl’. An alert message may be transmitted to the output device 135 from the controller 105 when ‘tl’ is completed and prior to completing ‘tl’, such as a pre-warning message that maintenance is due shortly. The value of ‘tl’ may be predetermined for each subsystem.

In order to estimate the number of cycles left to reach ‘tl’ and trigger appropriate alert messages, the controller 105 computes the working speed (ws) of the subsystem 115. The working speed ‘ws’ is based on the working time (wt) and working cycles (wc) performed by the subsystem 115. The ‘wt’ is a period of time that the system 100 is powered on. Printers and other systems typically include conventional circuitry for determining ‘wt’, and the ‘wt’ may be stored in the memory 120. The ‘wc’ may be determined for each subsystem, and printers and other systems typically include circuitry for recording the ‘wc’. The ‘wc’ for the subsystem 115 may also be stored in the memory 120. The ‘ws’ may be calculated based on the following equation 1:

wsᵢⱼ=wcᵢⱼ/wtⱼ (equation 1)

The ‘ws’ may be calculated for each subsystem ‘i’ (e.g., subsystem 115) during a period of time ‘j’ (i.e., wtⱼ) and stored in the memory 120. Also, the ‘ws’ may be calculated each time the system 100 is turned off or enters standby mode.

An estimated working speed (wse) is then determined from the calculated ‘ws’. The ‘wse’ is an estimate of the working speed of the system 100 during the time period before reaching ‘cl’. A triggering value (tv) is determined from the ‘wse’ and is calculated based on the following equation 2:

tvᵢ=clᵢ−(wseᵢ*tlᵢ) (equation 2)

The ‘tv’ is a number of working cycles, and an alert message may be generated when the subsystem ‘i’ reaches the number of cycles ‘tv’. The number of working cycles ‘tv’ is generally less than the maximum number of cycles before failure ‘cl’, and an alert message is generated when the number of total cycles completed by the subsystem ‘i’ reaches ‘tv’. Therefore, an alert message may be generated before the subsystem is expected to fail, and the elapsed working time for the subsystem ‘i’ prior to generating the alert message is a function of the actual working speed ‘ws’ of the subsystem ‘i’.

The ‘wse’ allows an alert message to be dynamically triggered based on the actual use of the system 100. This dynamic triggering of an alert message can facilitate improved maintenance scheduling and extend the life of the system 100.

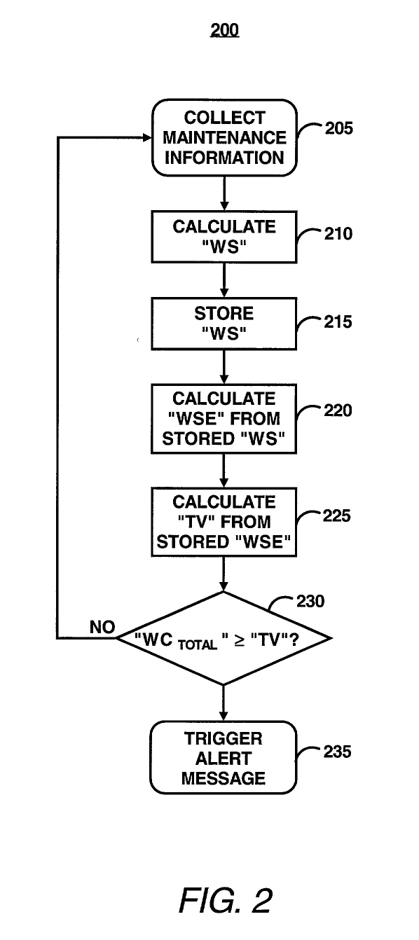

FIG. 2 illustrates an exemplary method 200 for determining a triggering value based on an estimated working speed of a subsystem. In step 205, the controller 105 collects maintenance information from the subsystem 115. For example, the controller 105 collects the ‘wc’ performed by the subsystem 115 during a period of time ‘j’ (i.e., wtⱼ) and stores the ‘wc’ and the ‘wtⱼ’ in the memory 120.

In step 210, the controller 105 calculates ‘wsⱼ’ for the period ‘j’. Thus, the working speed (wsⱼ) is calculated using ‘wc’ and ‘wt’ in equation 1 for the time period ‘j’ and for the subsystem 115.

In step 215, the calculated ‘wsⱼ’ is stored in the memory 120. The memory 120 may store multiple values of ‘ws’ calculated for different time periods. Alternatively, if limited memory is available, the memory 120 may store a single value for ‘ws’.

In step 220, ‘wse’ is calculated based on one or more stored values for ‘ws’. In one embodiment, when limited memory (e.g., one register for storing ‘wsⱼ’ in the memory 120) is available for storing ‘wsⱼ’, the ‘wse’ may be determined by calculating an average of a stored ‘wsⱼ’ (e.g., working speed calculated for a time period ‘j’) and a recently calculated ‘wsᵢ’ (e.g., a working speed calculated for a later time period ‘i’). This average may be stored as ‘wse’ in the memory 120. In another embodiment, a stored ‘wsⱼ’ is compared with a recently calculated ‘wsᵢ’, and the larger of the two is stored as ‘wse’.

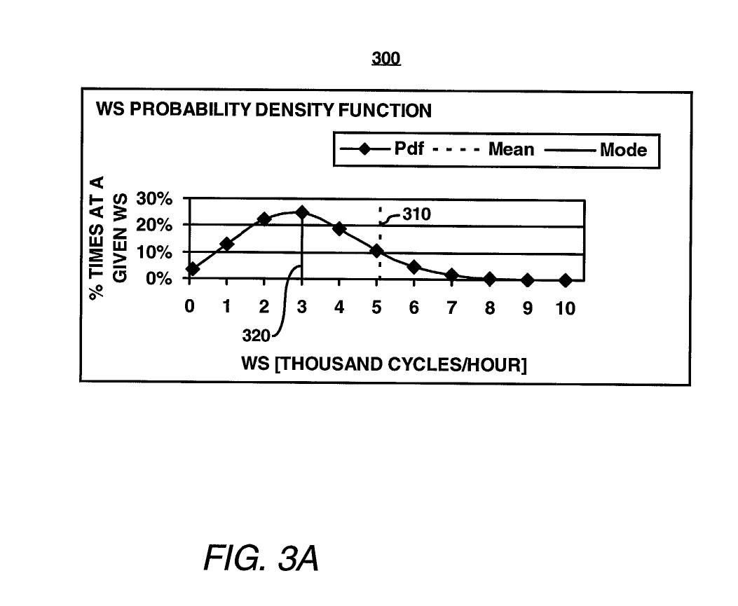

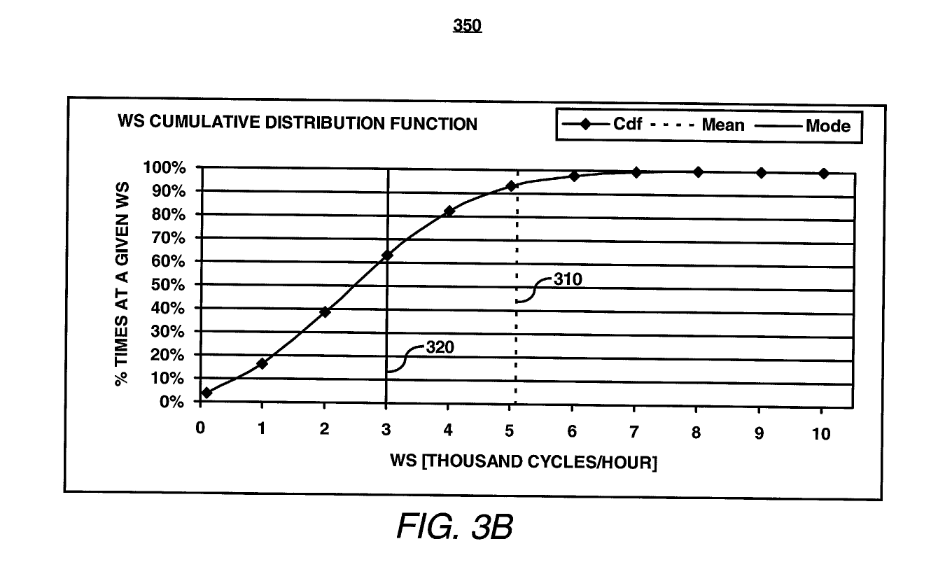

When more memory is available for storing multiple values of ‘ws’ calculated for multiple time periods, statistical analysis may be performed on the stored values of ‘ws’ for accurately estimating ‘wse’. For example, the stored values of ‘ws’ for the subsystem 115 may be analyzed as a set of samples from a continuous distribution. FIG. 3A illustrates a graph 300 of a probability density function of ‘ws’, and FIG. 3B illustrates a graph 350 of a cumulative distribution function for the same values of ‘ws’ used to calculate the probability density function. A mean 310 of the multiple stored values of ‘ws’ and a mode 320 (i.e., the most probable ‘ws’ value) is illustrated in both graphs 300 and 350.

In one embodiment for calculating ‘wse’, a mean (e.g., the mean 310) is calculated from the stored values of ‘ws’, and the mean may be stored as ‘wse’ in the memory 120. In another embodiment, the most probable value (e.g., the mode 320) of the stored values of ‘ws’ values is determined and stored as ‘wse’ in the memory 120.

In still another embodiment for calculating ‘wse’, a value of ‘ws’ is selected that encompasses 99.99% of the stored values of ‘ws’, such as a 99.99% value of ‘ws’ on the graph 350 (e.g., the value of ‘ws’ on the cumulative distribution curve in the graph 350 that corresponds to 99.99% on the y-axis). For this embodiment, the probability of exceeding the maximum cycles ‘cl’ prior to triggering an alert message is 0.01%. It will be apparent to one of ordinary skill in the art that other large percentages may be selected that encompass a large population of the values of ‘ws’ stored in the memory 120 for the subsystem 115.

In still another embodiment for calculating ‘wse’, a maximum error allowed is used to determine when to trigger an alert message. The maximum stored value of ws is set equal to ‘wse’. Then, a trigger value ‘tv’ is calculated using a maximum error allowed (mea) and with the following equation 3:

wse≧maxws*(1−(mea/tl)) (equation 3)

The ‘mea’ is a maximum error allowed for ‘tl’. For example, if ‘tl’ is 1 month, a reasonable error allowed may be 2 days. Therefore, instead of reaching ‘cl’ within 1 month, ‘cl’ is reached within 1 month minus 2 days. Thus, an alert message may be triggered in 29 days instead of 31 days. Utilizing the ‘mea’ further mitigates the risk of reaching ‘cl’ prior to the expiration of the period of time ‘tl’. As it can be seen form the above formula, when no maximum error is allowed, ‘wse’ is the maximum value of ‘ws’ (i.e., ‘maxws’) stored in the memory 120 for the subsystem 115.

In step 225, the triggering value ‘tv’ is calculated from the ‘wse’ calculated in step 220. For example, ‘tv’ is calculated using equation 2 for the subsystem 115.

In step 230, the controller 105 determines whether ‘wcₜₒₜₐₗ’ for the subsystem 115 (i.e., a running total of the number cycles completed by the subsystem 115) is greater than or equal to ‘tv’ calculated in step 225. The ‘wcₜₒₜₐₗ’ may be stored in the memory 120 by the controller 105 or the subsystem 115 detecting completed cycles. If the ‘wcₜₒₜₐₗ’ is greater than or equal to ‘tv’, then an alert message is triggered, for example, on the output device 135 (step 235). The alert message may indicate that the subsystem 115 is due to be serviced. If the ‘wcₜₒₜₐₗ’ is not greater than or equal to ‘tv’, then step 205 is performed.

The method 200 has generally been described with respect to the system 100, shown in FIG. 1. However, the method 200 is applicable to multiple subsystems operating in a single system. For example, vehicles include multiple subsystems that may utilize the method 200. Presses and other machinery may also utilize the method 200.

The method 200 can be performed by a computer program. The computer program can exist in a variety of forms both active and inactive. For example, the computer program and objects can exist as software comprised of program instructions or statements in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method for adaptively triggering an alert message for a subsystem in a device, the method comprising steps of:
determining a rate of use of the subsystem;
adjusting a predetermined threshold based on the determined rate of use; and
generating the alert message for the subsystem when the adjusted threshold is reached.

2. The method of claim 1, wherein the predetermined threshold is a predetermined number of cycles performed by the subsystem, and the step of adjusting further comprises adjusting the predetermined threshold to include a larger number of cycles than the predetermined number of cycles or a smaller number of cycles than the predetermined number of cycles.

3. The method of claim 2, wherein the step of generating the alert message further comprises generating the alert message for the subsystem if the adjusted predetermined number of cycles is completed.

4. The method of claim 3, wherein the step of determining the rate of use of the subsystem further comprises steps of:
calculating a plurality of working speeds; each working speed equaling a number of cycles performed by the subsystem during a period of time; and
calculating the rate of use based on the plurality of working speeds, the rate of use being an estimate of the rate of use of the subsystem during a period of time for the subsystem to complete the predetermined number of cycles.

5. The method of claim 4, wherein the step of calculating the rate of use further comprises steps of:
comparing one of the plurality of working speeds calculated for a recent period of time with another one of the plurality of working speeds calculated for a period of time previous to the recent period of time; and
storing a larger one of the compared working speeds as the rate of use.

6. The method of claim 4, wherein the step of calculating the rate of use further comprises steps of:
averaging one of the plurality of working speeds calculated for a recent period of time with another one of the plurality of working speeds calculated for a period of time previous to the recent period of time; and
storing the average as the rate of use.

7. The method of claim 4, wherein the step of calculating the rate of use further comprises steps of:
averaging the plurality of working speeds; and
storing the average as the rate of use.

8. The method of claim 4, wherein the step of calculating the rate of use further comprises lads steps of:
performing a statistical analysis on the plurality of working speeds to determine the working speed having a highest probability of occurring; and
storing the working speed having the highest probability of occurring as the rate of use.

9. The method of claim 4, wherein the step of calculating the rate of use further comprises steps of:
performing a cumulative, distribution, statistical analysis on the plurality of working speeds to determine a working speed greater than a large percentage of a cumulative distribution of the plurality of working speeds; and
storing the working speed greater than the large percentage of the cumulative distribution as the rate of use.

10. The method of claim 4, wherein the step of calculating the rate of use further comprises steps of:
determining a largest of the plurality of speeds; and
calculating the rate of use as a function of the largest working speed, a predetermined maximum error value and a predetermined period of time to reach the predetermined number of cycles.

11. The method of claim 10, wherein the maximum error value is a period of time and the function includes multiplying the largest working speed with a percentage based on the predetermined maximum error divided by the predetermined number of cycles.

12. The method of claim 1, wherein the alert message is a message indicating that preventive maintenance is due for the subsystem.

13. An apparatus having a plurality of subsystems, the apparatus comprising:
a controller connected to a memory, at least one subsystem and an output device, the controller being operable to determine a rate of use of the at least one subsystem, to adjust a predetermined threshold based on the determined rate of use, and to generate with the output device an alert message for the subsystem if the adjusted threshold is reached.

14. The apparatus of claim 13, wherein the predetermined threshold is a predetermined number of cycles performed by the at least one subsystem, and the controller is configured to adjust the predetermined threshold to include a larger number of cycles than the predetermined number of cycles or a smaller number of cycles than the predetermined number of cycles.

15. The apparatus of claim 14, wherein the controller is operable to generate the alert message on the output device if the predetermined number of cycles are completed by the at least one subsystem.

16. The apparatus of claim 15, wherein the controller is operable to collect maintenance information for the at least one subsystem, the maintenance information including working cycles performed by the at least one subsystem for a plurality of periods of time.

17. The apparatus of claim 14, wherein the controller is operable to calculate a working speed for each of the plurality of periods of time, and stores each working speed in the memory, each working speed being the number of working cycles performed by the at least one subsystem during the associated period of time.

18. The apparatus of claim 17, wherein the controller is operable to calculate the rate of use based on the stored working speeds, the rate of use being an estimate of the rate of use of the subsystem during a period of time for the subsystem to complete the predetermined number of cycles.

19. The apparatus of claim 18, wherein the rate of use is an average of the stored working speeds.

20. The apparatus of claim 18, wherein the controller is operable to perform statistical analysis on the stored working speeds to determine the stored working speed having a highest probability of occurring in the future, and stores in the memory the working speed having the highest probability of occurring in the future as the rate of use.

21. The apparatus of claim 18, wherein the rate of use is a function of a cumulative distribution of the stored working speeds.

22. A printer having a plurality of subsystems, the printer comprising:
a controller connected to a memory, at least one subsystem and an output device, the controller being operable to determine a rate of use of the at least one subsystem, to adjust a predetermined threshold based on the determined rate of use, and to generate with the output device an alert message for the subsystem when the adjusted threshold is reached.
